(19) United States
(12) Patent Application Publication
(10) Pub. No.: US 2013/0194939 A1
(43) Pub. Date: Aug. 1, 2013

(54) TRANSCEIVER

(71) Applicants: Jouni Kristian Kaukovuori, Vantaa (FI); Antti Oskari Immonen, Helsinki (FI)

(72) Inventors: Jouni Kristian Kaukovuori, Vantaa (FI); Antti Oskari Immonen, Helsinki (FI)

(73) Assignee: RENESAS MOBILE CORPORATION, Tokyo (JP)

(21) Appl. No.: 13/413,988

(22) Filed: Mar. 7, 2012

(30) Foreign Application Priority Data
Jan. 30, 2012 (GB) 1201616.8

(51) Int. Cl. H04J 3/14; H04J 1/00; H04J 1/16; H04J 3/00

(52) U.S. Cl. 370/252; 370/280

(57) ABSTRACT

Embodiments of the invention provide a method of configuring a transceiver to transmit and receive signals at a plurality of frequencies including at least a first transmitted signal modulated at a first transmission frequency, a first received signal modulated at a first reception frequency, and a second transmitted signal modulated at a second transmission frequency, the method comprising:
responsive to detecting desensitisation at the first reception frequency, configuring the transceiver so that at least two of the first received signal, the first transmitted signal and the second transmitted signal are transceived in a partial time division duplex, frequency division duplex mode.
Embodiments also include apparatus comprising a transceiver, the apparatus being suitably configured to perform the method.

### CROSS REFERENCE TO RELATED APPLICATION

This application claims benefit under 35 U.S.C. §119(a) and 37 CFR 1.55 to UK patent application no. 1201616.8, filed on 30 Jan. 2012, the entire content of which is hereby incorporated by reference.

### TECHNICAL FIELD

The present invention relates to transceivers for radio communication systems, and in particular, transceivers for use with carrier aggregation schemes.

### BACKGROUND

Radio communication schemes are used to define how parties communicate via an available portion of the frequency spectrum. Typically this communication may be between a user equipment (UE), such as a mobile telephony device, and a remote party, such as a basestation. Many modern radio communication schemes utilise frequency division duplexing (FDD), wherein the transmitted and received signals are modulated at different carrier frequencies in order to facilitate simultaneous two-way communication between the parties.

Long Term Evolution (LTE) Advanced is a mobile telecommunication standard proposed by the 3rd Generation Partnership Project (3GPP) and first standardised in 3GPP Release 10. In order to provide the peak bandwidth requirements of a 4th Generation system as defined by the International Telecommunication Union Radiocommunication (ITU-R) Sector, while maintaining compatibility with legacy mobile communication equipment, LTE Advanced proposes the aggregation of multiple carrier signals in order to provide a higher aggregate bandwidth than would be available if utilising a single carrier signal. This technique is called carrier Aggregation (CA). Hence, for a UE to be capable of CA there is a requirement for its transceiver to be able to transmit and receive multiple signals at multiple carrier frequencies. Carrier Aggregation can be used also in other radio communication protocols such as High Speed packet Access (HSPA).

FIG. 1 illustrates an exemplary signal spectrum, from the perspective of an antenna of a transceiver of e.g. a user equipment, on frequency-amplitude graph 100. Communication takes place via pairs of signals in two frequency regions 102, 108. A first frequency region 102 comprises transmitted signal 104 and received signal 106. Transmitted signal 104 is modulated at transmission frequency f_{T×1}, and is used to transmit data from the transceiver to a remote party. Received signal 106 is modulated at reception frequency f_{R×1}, and is used to receive data that has been transmitted from the remote party to the transceiver. Transmitted signal 104 will typically be of higher magnitude than received signal 106, as it has been generated locally. In contrast, because received signal 106 has been generated remotely and has propagated some distance through the transmission medium before arriving at the transceiver, it is attenuated during transmission.

Similarly, a second frequency region 108 comprises transmitted signal 110 and received signal 112. Transmitted signal 110 is modulated at transmission frequency f_{T×2}, and is used to transmit data from the transceiver to a remote party. This could be the same, or a different, remote party to which transmitted signal 104 is transmitted. Received signal 112 is modulated at reception frequency f_{R×2}, and is used to receive data transmitted from the remote party to the transceiver. Whilst the second pair of signals is shown to have the same amplitude as the first, this may not be the case in practice. For example, the different carrier frequencies used may result in different propagation paths between the UE and the remote party, with differing attenuation characteristics. Also, if communication involves multiple remote parties, the propagation paths between the UE and the various remote parties will be different, and are therefore likely to have different attenuation characteristics.

Depending on the type of communication scheme being used, the pair of signals in the first frequency region 102 could be allocated in the same frequency band as the pair of signals in the second frequency region 108 (e.g. intra-band CA), or in a different frequency band entirely (e.g. inter-band CA). The non linearity of the frequency axis of frequency-amplitude graph 100 is shown by the breaks in the frequency axis between the origin and the first frequency region 102, and between the first frequency region 102 and the second frequency region 108. Although the reception frequencies shown in FIG. 1 are illustrated as being allocated at a higher frequency than the transmission frequency in each frequency region, it is equally possible for either, or both, of the reception frequencies to be allocated at a lower frequency than the transmission frequency in the same region.

It has been noted that problems arise when the pairs of frequency channels are allocated at significantly different frequencies. Specifically, when combined with one another, the nonlinearity of the active and passive components in a transceiver can result in intermodulation distortion. Components of this intermodulation distortion are centred on sum and difference combinations of the carrier frequencies of the transmitted signals (e.g. third order harmonic distortion results at 2*f_{T×1}−f_{T×2}, or at 2*f_{T×2}−f_{T×1}). When the transmitted signals are modulated at transmission frequencies that are not relatively similar (e.g. not in the same frequency band), it becomes more likely that intermodulation components will be generated near to one of the transceived signals.

Harmonic generation can also result in similar distortion components. As is known in the art, harmonic components of a given transmitted signal are generated at multiples of the transmission frequency. When the pair of signals in the first frequency region 102 are allocated at a substantially different frequency to that of the pair of signals in the second frequency region 108, it becomes more likely that a harmonic component of the lower frequency transmitted signal will be generated near to one of the higher frequency signals.

FIG. 2 illustrates the effects of distortion on an exemplary signal spectrum, from the perspective of the antenna of a transceiver, on frequency-amplitude graph 200. A first frequency region 202 comprises transmitted signal 204 and received signal 206. Transmitted signal 204 is modulated at transmission frequency f_{T×1}, and is used to transmit data from the transceiver to a remote party. Received signal 206 is modulated at reception frequency f_{R×1}, and is used to receive data transmitted from the remote party to the transceiver.

Similarly, a second frequency region 208 comprises transmitted signal 210 and received signal 212. Transmitted signal 210 is modulated at transmission frequency f_{T×2}, and is used to transmit data from the transceiver to a remote party. Received signal 212 is modulated at reception frequency f_{R×2}, and is used to receive data transmitted from the remote party to the transceiver.

As a result of the allocation of these particular frequency channels, a distortion component 214 has been generated close to the reception frequency f_{R×2}, and in this example overlaps received signal 202. Distortion component 214 could be an afore-mentioned intermodulation component generated by the combination of transmitted signals 204 and 210, or it could be an afore-mentioned harmonic component of transmitted signal 204. The effect of this distortion component 214 is desensitisation of the receiver to the reception of received signal 202. If the magnitude of the generated distortion component is sufficiently large, the transceiver will become unable to reliably receive signals received at reception frequency f_{R×2} (i.e. received signal 212), thereby impeding the operation of the transceiver. Although the distortion component shown in FIG. 2 is generated near the higher frequency reception frequency, it is equally possible for the intermodulation component to be generated over a lower frequency reception frequency (e.g. f_{R×1}).

FIG. 3 provides an alternative illustration of the effects of distortion on an exemplary signal spectrum, from the perspective of the antenna of a transceiver, on time-frequency graph 300. At time t₀ the pair of signals allocated in frequency region 308 (i.e. transmitted signal 310 and received signal 312 modulated at frequencies f_{T×2} and f_{R×2} respectively) are being transmitted and received. At time t₁, the pair of signals allocated in frequency region 302 (i.e. transmitted signal 304 and received signal 306 modulated at frequencies f_{R×1} and f_{R×1} respectively) also begin to be transmitted and received. The inclusion of transmitted signal 304 causes distortion component 314 to be generated near reception frequency f_{R×2}, overlapping received signal 312. The result is desensitisation of the transceiver to received signal 312 from time t₁ onwards. As for the preceding example, distortion component 314 could be a harmonic component of transmitted signal 304, or an intermodulation component arising from the combination of transmitted signals 304 and 310.

As an alternative to transmitted signal 304 beginning transmission at time t₁, a scheduled change in reception/transmission frequency of one of the transmitted/received signals could also have resulted in the appearance of distortion component 314.

Since the magnitude of the distortion component is proportional to the magnitude of one (in the case of a harmonic component) or more (in the case of an intermodulation component) of the transmitted signals, reducing the magnitude of one or more of the transmitted signals could reduce the extent of any desensitisation at a reception frequency. However, the magnitude of a transmitted signal is typically configured to be sufficient for effective reception by the remote party. Configuring a transmitted signal to be generated with lower than the required magnitude jeopardises reliable communication with the remote party, thereby impeding the operation of the transceiver.

In the case of harmonic distortion, the magnitude of any harmonic components of a transmitted signal could be attenuated through the use of a band-pass or low-pass filter located between a transmitter part of the transceiver and the antenna. However this incurs additional expense, causes unwanted losses at the desired transmission frequency and can be ineffective due to poor impedance matching outside of the intended operating frequency range of the transmitter part.

Hence, it is an object of the present disclosure to present improved methods and systems for transmitting and receiving multiple signals, particularly under conditions where distortion components cause desensitisation to one or more of the received signals.

### SUMMARY

In accordance with exemplary embodiments, there is provided a transceiver, apparatus comprising a transceiver, a method of configuring a transceiver and a non-transitory computer-readable storage medium comprising a set of computer-readable instructions stored thereon, which, when executed by a processing system, cause the processing system to carry out a method of configuring a transceiver, to transmit and receive signals at a plurality of frequencies including at least a first transmitted signal modulated at a first transmission frequency, a first received signal modulated at a first reception frequency, and a second transmitted signal modulated at a second transmission frequency.

In a first exemplary embodiment, there is provided a method for configuring a transceiver, comprising: responsive to detecting desensitisation at the first reception frequency, the transceiver is configured so that at least two of the first received signal, the first transmitted signal and the second transmitted signal are transceived in a partial time division duplex, frequency division duplex mode.

In accordance with a second exemplary embodiment, there is provided an apparatus comprising a transceiver, wherein, responsive to detecting desensitisation at the first reception frequency, the apparatus is configured to cause the transceiver to transceive at least two of the first received signal, the first transmitted signal and the second transmitted signal in a partial time division duplex, frequency division duplex mode.

In accordance with a third exemplary embodiment, there is provided a non-transitory computer-readable storage medium comprising a set of computer-readable instructions stored thereon, which, when executed by a processing system, cause the processing system to carry out a method of configuring a transceiver, wherein, responsive to detecting desensitisation at the first reception frequency, configuring the transceiver so that at least two of the first received signal, the first transmitted signal and the second transmitted signal are transceived in a partial time division duplex, frequency division duplex mode.

Hence, by configuring one of the transmitted signals into exclusive time domain operation with respect to either the afflicted received signal or the other transmitted signal, the effects of the desensitisation upon the reliability of the ongoing operation of the transceiver can be alleviated. Further features and advantages of the exemplary embodiments will become apparent from the following description of preferred embodiments, given by way of example only, which is made with reference to the accompanying drawings.

### BRIEF DESCRIPTION OF THE DRAWINGS

FIG. 1 illustrates an exemplary signal spectrum, from the perspective of the antenna of a transceiver, on frequency-amplitude graph 100.

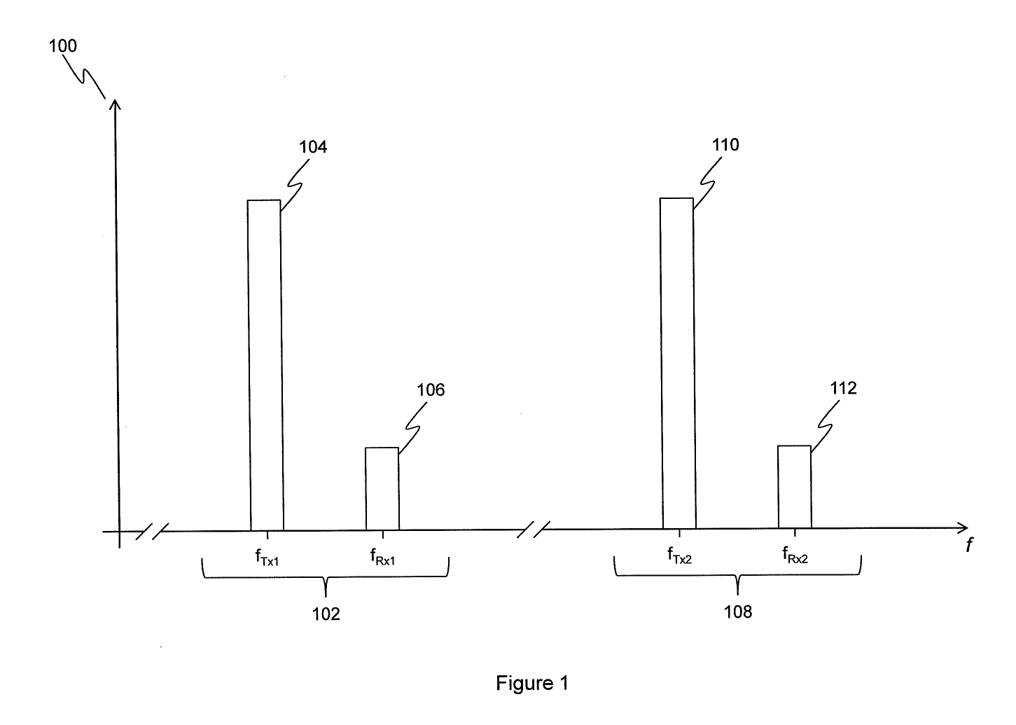

FIG. 2 illustrates the effects of distortion on an exemplary signal spectrum, from the perspective of the antenna of a transceiver, on frequency-amplitude graph 200.

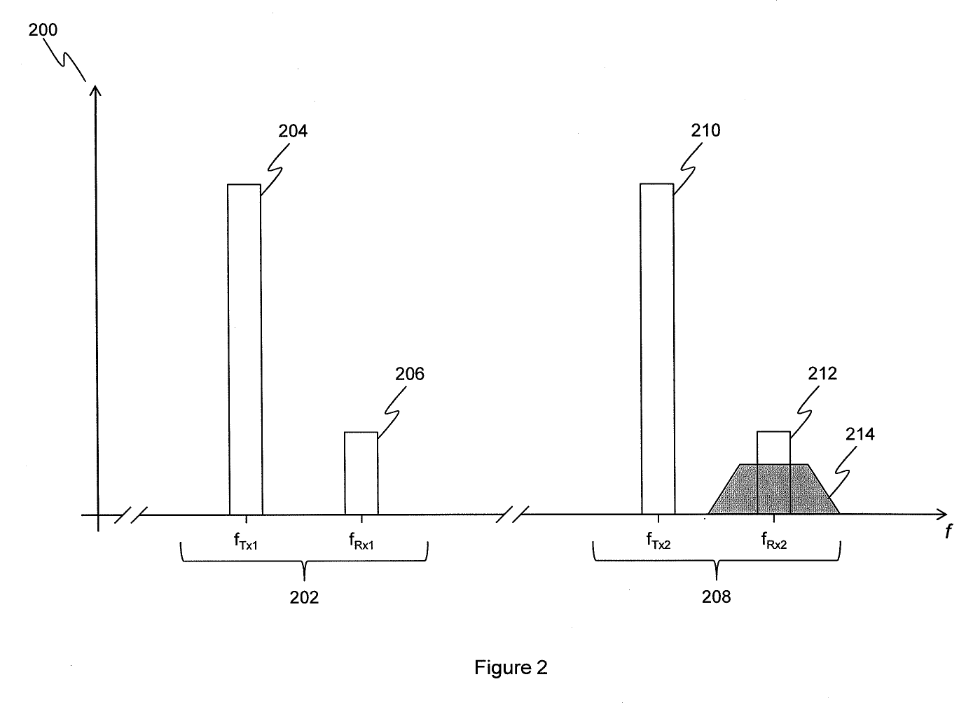

FIG. 3 provides an alternative illustration of the effects of distortion on an exemplary signal spectrum, from the perspective of the antenna of a transceiver, on time-frequency graph 300.

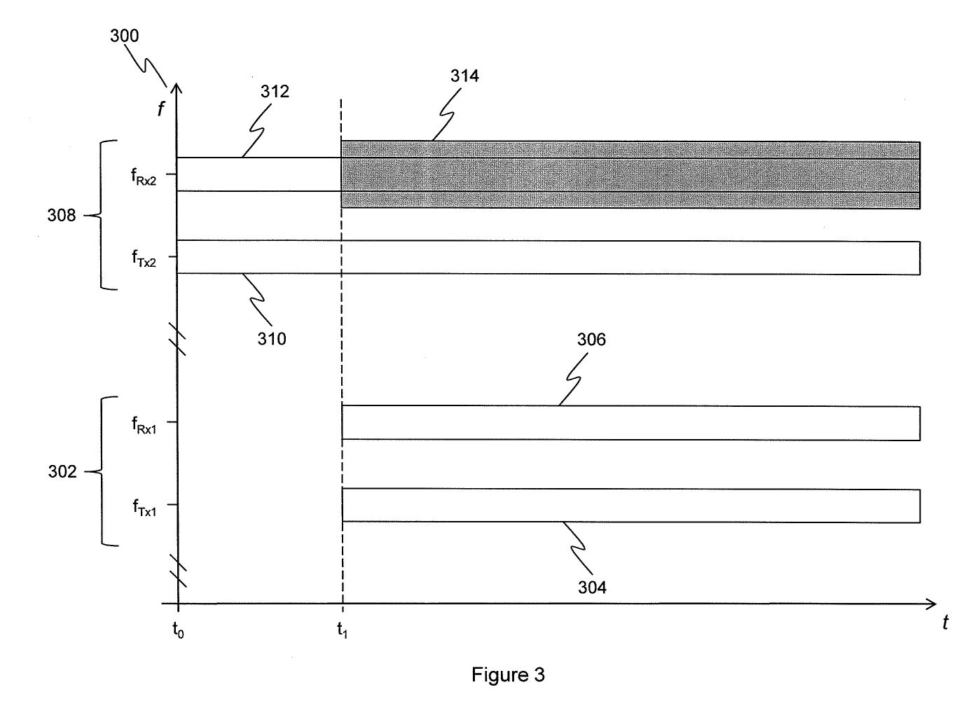

FIG. 4 illustrates the operation of a transceiver according to embodiments of the disclosure on time-frequency graph 400.

FIG. 5 illustrates the operation of a transceiver according to further embodiments of the disclosure on time-frequency graph 500.

FIG. 6 illustrates the operation of a transceiver according to yet further embodiments of the disclosure on time-frequency graph 600.

FIG. 7 illustrates subsequent operation of a transceiver according to embodiments of the disclosure on time-frequency graph 700.

FIG. 8 illustrates subsequent operation of a transceiver according to further embodiments of the disclosure on time-frequency graph 800.

FIG. 9 illustrates subsequent operation of a transceiver according to yet further embodiments of the disclosure on time-frequency graph 900.

FIG. 10 illustrates further effects of distortion on an exemplary signal spectrum, from the perspective of the antenna of a transceiver, on frequency-amplitude graph 1000.

FIG. 11 illustrates the operation of a transceiver according to additional embodiments of the disclosure on time-frequency graph 1100.

FIG. 12 illustrates the operation of a transceiver according to further additional embodiments of the disclosure on time-frequency graph 1200.

FIG. 13 illustrates the operation of a transceiver according to yet further additional embodiments of the disclosure on time-frequency graph 1300.

FIG. 14 is a simplified block diagram of various network devices and a user terminal which may include the transceiver described in relation to FIGS. 4-13.

FIG. 15 is a logic flow diagram that illustrates the steps involved in configuring a transceiver according to an embodiment of the disclosure.

### DETAILED DESCRIPTION

Embodiments of the disclosure provide a transceiver capable of transmitting and receiving signals at a plurality of frequencies, by selectively configuring a time division duplex relationship between two of the transceived signals.

When the transceiver detects desensitisation at a particular reception frequency, the transceiver is configured to transmit one of the transmitted signals in a partial time division duplex, frequency division duplex mode with respect to either the signal received at the desensitised reception frequency, or another of the transmitted signals. Under this mode of operation, the transceiver either no longer transmits one of the transmitted signals when a signal is received at the afflicted reception frequency, or no longer transmits both transmitted signals at the same time. As long as one of the now partial time division duplex transmitted signals contributed to the detected desensitisation, the effects of the desensitisation upon the reliability of the ongoing operation of the transceiver will be alleviated.

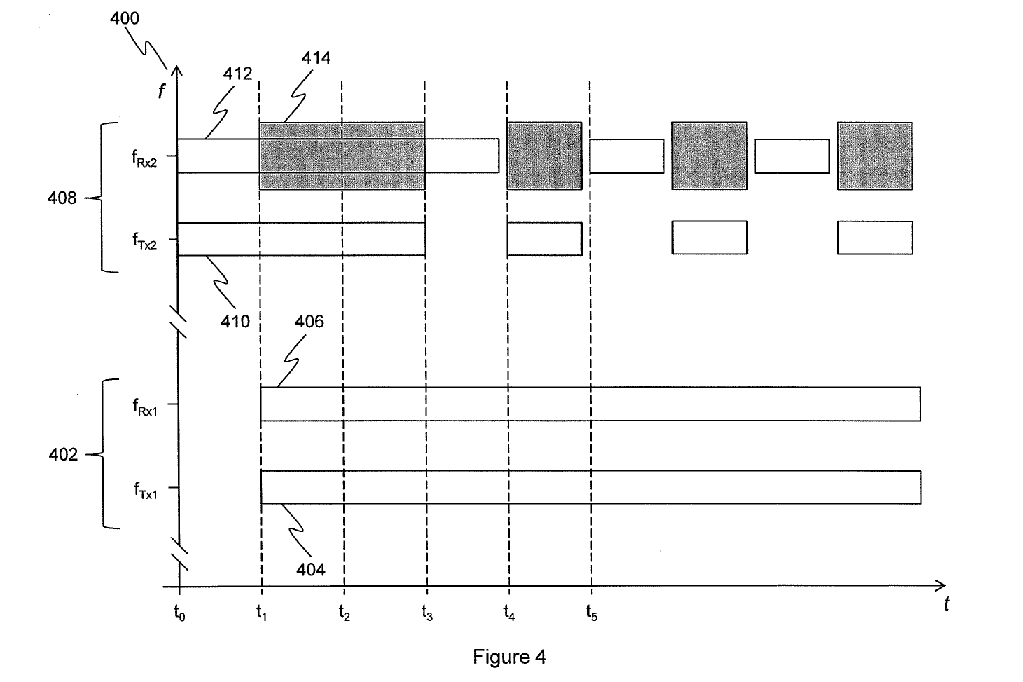

FIG. 4 illustrates the operation of a transceiver according to embodiments with respect to time-frequency graph 400. At time t₀ a pair of signals allocated in frequency region 408 (transmitted signal 410 and received signal 412 modulated at frequencies f_{T×2} and f_{R×2} respectively) are being transmitted and received. At time t₁, a pair of signals allocated in frequency region 402 (transmitted signal 404 and received signal 406 modulated at frequencies f_{T×1} and f_{R×1} respectively) also begin to be transmitted and received. The addition of transmitted signal 404 causes distortion component 414 to be generated near reception frequency f_{R×2}, overlapping received signal 412. In this example, distortion component 414 is an intermodulation component arising from the combination of transmitted signals 404 and 410. The result is desensitisation of the transceiver to signals received at reception frequency f_{R×2}, beginning at time t₁.

At time t₂, the transceiver detects the desensitisation to signals received at reception frequency f_{R×2}, and configures the transceiver so that received signal 412 and one of the transmitted signals 404 and 410 are transceived in a partial time division duplex, frequency division duplex mode from time t₃ onwards. As the desensitisation is due to an intermodulation component resulting from the combination of transmitted signals 404 and 410, either of the transmitted signals can be selected for transmission in the partial time division duplex, frequency division duplex mode. In this example, transmitted signal 410 is selected.

Accordingly, between time t₃ and time t₄, the transceiver suspends transmission of transmitted signal 410 whilst signal 412 is being received. As transmitted signal 410 is not being transmitted during the period between time t₃ and time t₄, distortion component 414 is not generated, thereby allowing received signal 412 to be reliably received.

As can be seen, between time t₄ and time t₅, the transceiver is not receiving signal 412; as a result the transceiver resumes transmission of transmitted signal 410. Thus, while it is the case that transmitted signal 404 and transmitted signal 410 are both being transmitted, meaning that distortion component 414 is also generated, it is also the case that the distortion component 414 does not affect operation of the receiver because signal 412 is not being received during this period. This operation continues from time t₅ onwards, thereby allowing reliable communication to continue despite the generation of distortion component 414.

Although the distortion component shown in FIG. 4 was generated near the higher frequency reception frequency, it is equally possible for an intermodulation component to be generated near a lower frequency reception frequency (e.g. f_{R×1}). In such a case, the transceiver would be similarly configured so that the received signal that is suffering desensitisation and one of the transmitted signals are transceived in a partial time division duplex, frequency division duplex mode. This mode of operation enables reliable communication to continue regardless of which reception frequency is affected by the desensitisation.

Desensitisation of the transceiver to signals received at a given reception frequency may be determined in a number of ways. The transceiver may, given preconfigured knowledge of magnitude and frequency of the various transmitted signals being transmitted, perform one or more calculations to determine the frequency and magnitude of any generated distortion components. These can then be compared to the currently allocated reception frequencies to detect desensitisation on the basis of predicted distortion component parameters. Alternatively, the transceiver may perform a signal quality measurement process by measuring a signal quality of a received signal. This method has the advantage of being an established part of several conventional radio communication schemes, and hence introduces little additional computational overhead. The measured signal quality of a received signal can then be used to determine whether the transceiver is subject to desensitisation at the given reception frequency.

The operation of the transceiver can be improved by selectively configuring the transceiver into the partial time division duplex, frequency division duplex mode when the level of desensitisation experienced at the given reception frequency is sufficient to render reception of signals received at that frequency to be unreliable. This can be determined by comparing the measured or calculated signal quality with a predetermined threshold level, below which reception of the signal becomes unreliable. This predetermined threshold level can be tailored to a specific transceiver, for example in relation to that transceiver's ability to process low signal quality signals, or a specific application, for example in relation to a level of signal quality required for a given application. The threshold may also be variable over time in dependence on other factors, such as the amount of CPU resource currently available for the transceiver to process low quality signals.

Once the transceiver has detected desensitisation at a reception frequency, embodiments transmit data indicative of that desensitisation to the remote party from which the associated signal is received. This could be transmitted using one of the transmitted signals (i.e. in-band) or via another communication channel entirely (i.e. out of band). The data indicative of the detected desensitisation can be used by the transceiver to request that the remote party begins transmitting on an intermittent basis. This creates periods where the transceiver is not receiving at the desensitised reception frequency, thereby enabling the transmitter to transmit via both transmitted signals during such time. An example of such a period is that between t₄ and t₅ of FIG. 4.

Knowledge of the pattern of the intermittent transmission (i.e. transmission length and cycle period) by the remote party allows the transceiver to make effective use of the periods when no signal is being received. The synchronisation required between the transceiver and the remote party is not as strict as in a pure time division duplex radio communication scheme, as only the transceiver end needs to adhere to the strict scheduling. Unlike the transceiver, the remote party is not subject to the generated distortion components and is therefore free to receive signals while simultaneously transmitting. This makes the scheme easier to implement as the transceiver can synchronise itself entirely on the basis of the received signals, without concern for whether a transmitted signal will arrive at the remote party after the remote party has begun transmitting again.

The actual transmission length and cycle period used in the partial duplex, frequency division duplex mode can be varied according to a number of factors. Most simply, a 50:50 duty cycle may be used, wherein the proportionate transmission length of each signal is half of the cycle period. This has the advantage of being easy to implement and spreads the impact of the bandwidth reduction evenly among the transmitted and received signals. This type of arrangement is commonly known as half duplex, frequency division duplex. Alternatively, an asynchronous scheme may be implemented, wherein one of the signals is allocated a larger proportion of the cycle period for transmission. This allows the impact of the bandwidth reduction to be biased towards one of the transmitted or received signals. In an asynchronous scheme, the proportions of the cycle period allocated of each of the signals may be dynamically variable, allowing bandwidth to be allocated between the signals on the basis of current utilisation or requirements, such as a required transmission bandwidth compared to a required reception bandwidth.

The transceiver may use guard periods when switching between transmitting and receiving in the partial time division duplex, frequency division duplex mode. The use of guard periods helps prevent the distortion of the start or end of a received signal if errors in signal synchronisation at the transceiver cause the transmission and reception of those signals to overlap. Again these guard periods can be narrower than would be required in a pure time division duplex radio communication scheme, as only the transceiver end is subject to the strict scheduling constraints.

The choice of which of the transmitted signals to select for transmission in the partial time division duplex, frequency division duplex mode can be informed by a number of factors. If the two transmitted signals have different bandwidths available, selecting the transmitted signal with the lower available bandwidth for transmission in the partial time division duplex, frequency division duplex mode reduces the effect on total available transmission bandwidth when operating in that mode. Further, if the two transmitted signals have different numbers of resource blocks allocated, selecting the transmitted signal with the lower number of resource blocks for transmission in the partial time division duplex, frequency division duplex mode may be preferable. Additionally, if the two transmitted signals are affected by different transmission conditions, one may be able to transmit at a higher throughput than the other. Selecting the transmitted signal limited to the lower throughput for transmission in the partial time division duplex, frequency division duplex mode reduces the effect on total available transmission throughput when operating in that mode. The combination of one or more of these factors can be used to select the transmitted signal that allows a highest overall link capacity to be maintained.

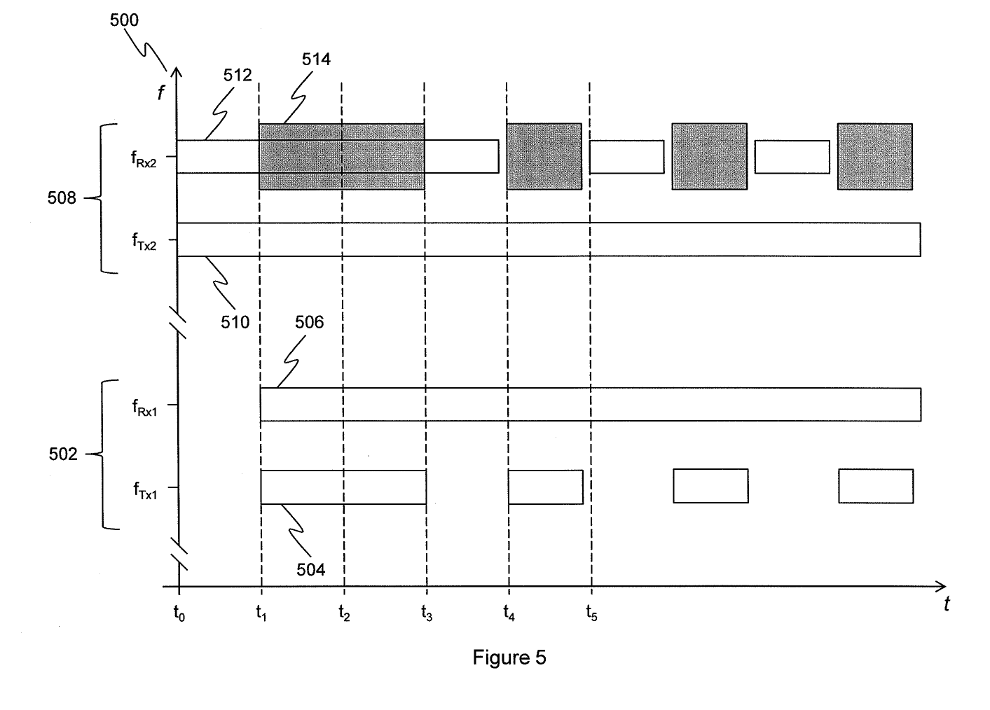

If the desensitisation is the result of a harmonic component, then the transmitted signal that is the source of the harmonic generation is selected for transmission in a partial time division duplex, frequency division duplex mode, as described below in relation to FIG. 5.

FIG. 5 illustrates the operation of a transceiver according to a further embodiment. At time t₀ a pair of signals allocated in frequency region 508 (transmitted signal 510 and received signal 512 modulated at frequencies f_{T×2} and f_{R×2} respectively) are being transmitted and received. At time t₁, a pair of signals allocated in frequency region 502 (transmitted signal 504 and received signal 506 modulated at frequencies f_{T×1} and f_{R×1} respectively) also begin to be transmitted and received. The addition of transmitted signal 504 causes distortion component 514 to be generated near reception frequency f_{R×2}, overlapping received signal 512. In this example, distortion component 514 is a harmonic component arising from the presence of transmitted signal 504. The result is desensitisation of the transceiver to signals received at reception frequency f_{R×2}, beginning at time t₁.

At time t₂, the transceiver detects the desensitisation to signals received at reception frequency f_{R×2}, and configures the transceiver so that received signal 512 and one of the transmitted signals 504 and 510 are transceived in a partial time division duplex, frequency division duplex mode from time t₃ onwards. As the desensitisation is due to a harmonic component resulting from the presence of transmitted signal 504, transmitted signal 504 is selected for transmission in the partial time division duplex, frequency division duplex mode.

Between time t₃ and time t₄, the transceiver suspends transmission of transmitted signal 504 whilst signal 512 is being received. As transmitted signal 504 is not being transmitted during the period between time t₃ and time t₄, distortion component 514 is not generated, thereby allowing received signal 512 to be reliably received.

As can be seen, between time t₄ and time t₅, the transceiver is not receiving signal 512; as a result the transceiver resumes transmission of transmitted signal 504. Thus, while it is the case that transmitted signal 504 and transmitted signal 510 are both being transmitted, meaning that distortion component 514 is also generated, it is also the case that the distortion component 514 does not affect operation of the receiver because signal 512 is not being received during this period. This operation continues from time t₅ onwards, thereby allowing reliable communication to continue despite the generation of distortion component 514.

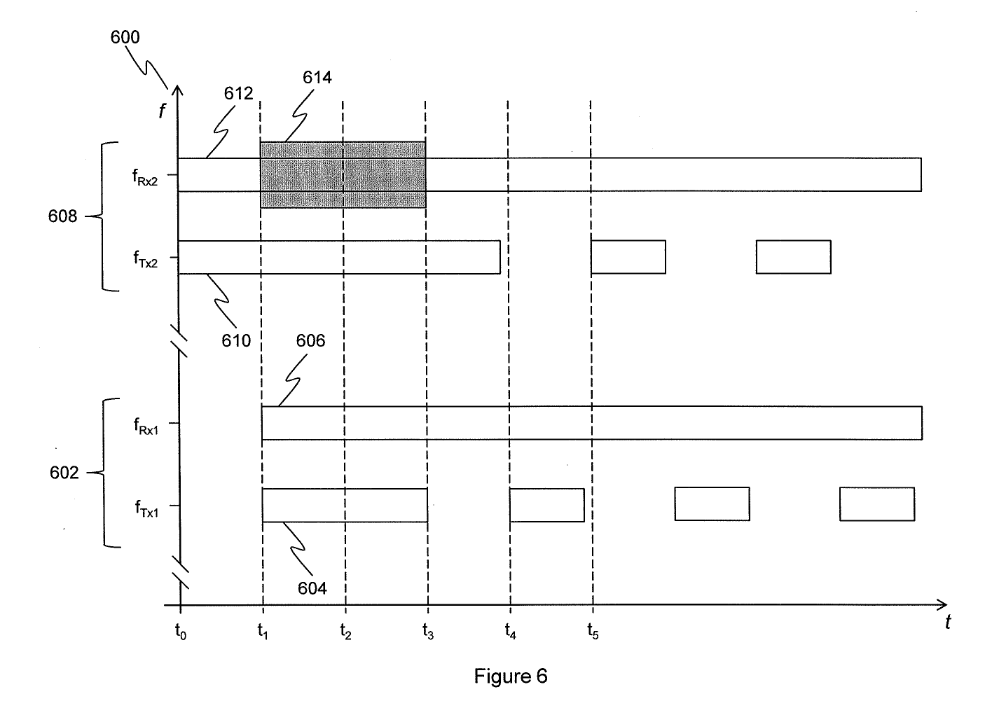

In many usage scenarios, it is more desirable to maintain a high aggregate bandwidth of signals received by a UE, than the aggregate bandwidth of any transmitted signals. In order to maximise the aggregate bandwidth of the received signals whilst suffering desensitisation at one of the received frequencies due to intermodulation distortion, the two transmitted signals may be configured into the partial time division duplex, frequency division duplex mode with respect to each other, whilst the afflicted received signal remains available for continuous reception. An arrangement in which the aggregate bandwidth of the received signals is maximised in this way is described below with relation to FIG. 6.

At time t₀ a pair of signals allocated in frequency region 608 (transmitted signal 610 and received signal 612 modulated at frequencies f_{T×2} and f_{R×2} respectively) are being transmitted and received. At time t₁, a pair of signals allocated in frequency region 602 (transmitted signal 604 and received signal 606 modulated at frequencies f_{T×1} and f_{R×1} respectively) also begin to be transmitted and received. The addition of transmitted signal 604 causes distortion component 614 to be generated near reception frequency f_{R×2}, overlapping received signal 612. In this example, distortion component 614 is an intermodulation component arising from the presence of transmitted signal 604 and transmitted signal 610. The result is desensitisation of the transceiver to signals received at reception frequency f_{R×2}, beginning at time t₁.

At time t₂, the transceiver detects the desensitisation to signals received at reception frequency f_{R×2}, and configures the transceiver so that transmitted signal 604 and transmitted signal 610 are transmitted in a partial time division duplex, frequency division duplex mode from time t₃ onwards.

Between time t₃ and time t₄, the transceiver suspends transmission of transmitted signal 604 whilst signal 610 is being transmitted. As transmitted signal 604 is not being transmitted during the period between time t₃ and time t₄, distortion component 614 is not generated, thereby allowing received signal 612 to be reliably received.

As can be seen, between time t₄ and time t₅, the transceiver suspends transmission of transmitted signal 610 whilst signal 604 is being transmitted. As transmitted signal 610 is not being transmitted during the period between time t₃ and time t₄, distortion component 614 is still not generated, thereby allowing received signal 612 to continue being reliably received. Thus, while it is the case that transmitted signal 604 and transmitted signal 610 are both being transmitted, this no longer happens simultaneously, meaning that distortion component 614 is no longer generated. This operation continues from time t₅ onwards, thereby allowing reliable communication to continue despite the initial generation of distortion component 614.

Subsequent to the transceiver operating in the partial time division duplex, frequency division duplex mode, the magnitude of any distortion component at the afflicted reception frequency may vary over time. Under some conditions, the distortion component may be removed entirely from the reception frequency, or it may be reduced to a level that would allow for reliable reception of received signals in a full duplex, frequency division duplex mode. In these circumstances, there is bandwidth available for communication that is not being fully utilised due to continued operation in the partial time division duplex, frequency division duplex mode.

In order to detect when it would be possible to return to full duplex, frequency division duplex operation, some arrangements involve a continual assessment of the extent of desensitisation at the afflicted reception frequency when the transceiver is operating in the partial time division duplex, frequency division duplex mode. Again, the magnitude and frequency of any distortion components could be calculated, given knowledge of the magnitude and frequency of the transmitted signals, in order to detect the level of desensitisation at the afflicted reception frequency on the basis of predicted distortion component parameters. Alternatively, this could be determined by performing a signal quality measurement process.

The continual assessment of desensitisation at the afflicted reception frequency could be performed periodically whilst the transceiver is operating in the partial time division duplex, frequency division duplex mode, or in response to the occurrence of one or more assessment trigger conditions. Such trigger conditions might include a decrease in the magnitude of one of the transmitted signals (which may decrease the magnitude of any desensitisation component), an increase in the number of resource blocks allocated (which may allow the transceiver to reliably receive signals with a lower signal quality), or a change in carrier frequency of any of the transceived signals (which may change the frequency of any distortion component relative to afflicted received signal).

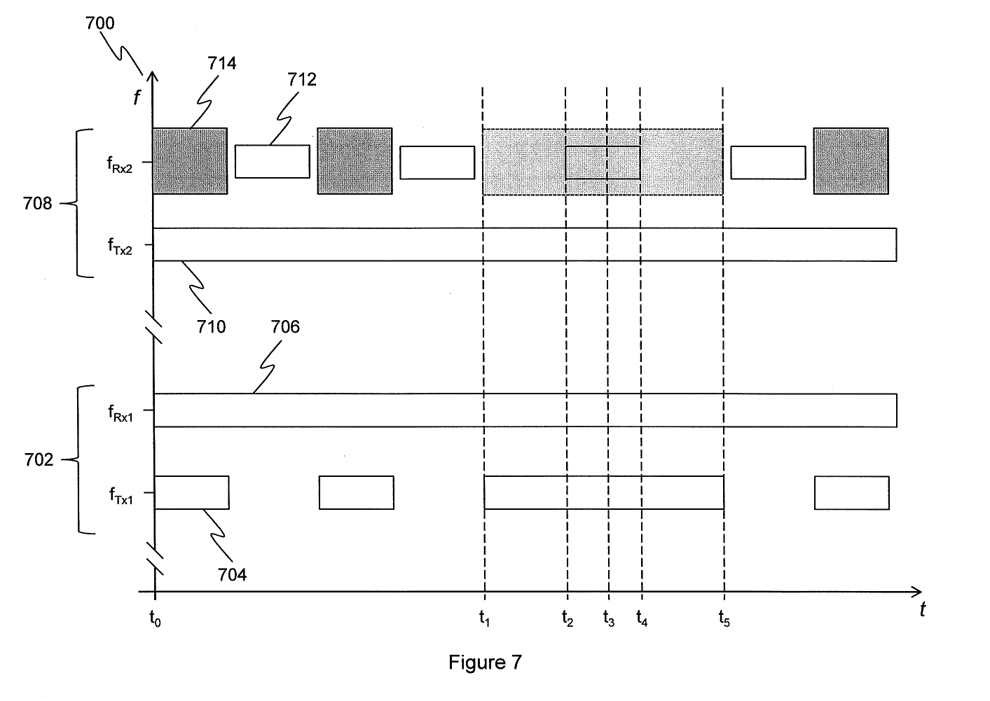

In order to determine the extent of any subsequent desensitisation on the basis of such a signal quality measurement process, it is necessary to be able to measure the signal quality of the received signal that will be subject to the presence of distortion components. It will be appreciated that the normal operation of the partial time division duplex, frequency division duplex mode is such that this is prevented from occurring. However, this can be achieved by introducing a test period of full duplex, frequency division duplex operation, whilst operating the partial time division duplex, frequency division duplex mode. An arrangement in which such a test period is introduced will now be described with reference to FIG. 7.

As was described with reference to FIGS. 4 and 5, a pair of signals allocated in frequency region 702, comprising transmitted signal 704 and received signal 706 modulated at frequencies f_{T×1} and f_{R×1} respectively, and a pair of signals allocated in frequency region 708, comprising transmitted signal 710 and received signal 712 modulated at frequencies f_{T×2 and f}_{R×2} respectively are being transmitted and received. Again, the combination of transmitted signal 704 and transmitted signal 710 results in the generation of distortion component 714 near reception frequency f_{R×2}, overlapping received signal 712. This again causes desensitisation of the transceiver to signals received at reception frequency f_{R×2}, and hence at time t₀ the transceiver has been configured to operate in the partial time division duplex, frequency division duplex mode with respect to received signal 712 and transmitted signal 704.

In order to determine the extent of a subsequent desensitisation using a signal quality measurement process, a test period of full duplex, frequency division duplex operation is inserted between t₂ and t₄, when the transceiver is operating in the partial time division duplex, frequency division duplex mode. This is achieved by continuing transmission of signal 704 throughout a period in which received signal 712 is scheduled to be received. The result is a continuous transmission of transmitted signal 704 from time t₁ to time t₅, which means that distortion component 714 is generated throughout that period.

At time t₃, during the test period of full duplex, frequency division duplex operation, the transceiver performs a signal quality measurement process in order to measure a signal quality of signal 712. On the basis of the measured signal quality, the transceiver determines that it is still subject to desensitisation as regards signals received at reception frequency f_{R×2}. Accordingly the transceiver continues to transceive received signal 712 and transmitted signal 704 in the partial time division duplex, frequency division duplex mode from time t₅ onwards.

Again, the operation of the transceiver can be improved by comparing the measured or calculated signal quality with a predetermined threshold level in order to determine whether the subsequent level of desensitisation experienced at the afflicted reception frequency is sufficient to render the reception of signals received at that frequency unreliable. This threshold level can be configured to be the same as the threshold level used previously, i.e. set at a level below which reception of the signal becomes unreliable. However, a further advantage may be obtained by configuring this threshold level to be somewhat higher than the threshold level used previously, in order to introduce hysteresis into the operation of configuring the transceiver between the partial time division duplex, frequency division duplex mode and the full duplex, frequency division duplex mode. This prevents rapid switching between the two modes when the desensitisation level fluctuates around the threshold level, and hence minimises any computational or scheduling overheads associated with the reconfiguration of the transceiver.

In the example of FIG. 7, it is assumed that the subsequent signal quality of received signal 712 during the test period of full duplex, frequency division duplex operation was not sufficient to allow for reliable reception. As such, any information carried by received signal 712 during that period may not have been received by the transceiver. Under these conditions the transceiver may be configured to request the retransmission of that data. Alternatively, the test period of full duplex, frequency division duplex operation can be scheduled such that no meaningful data is transmitted during that period. However, in either case, the signal quality measurement process is accompanied by a temporary reduction in received bandwidth.

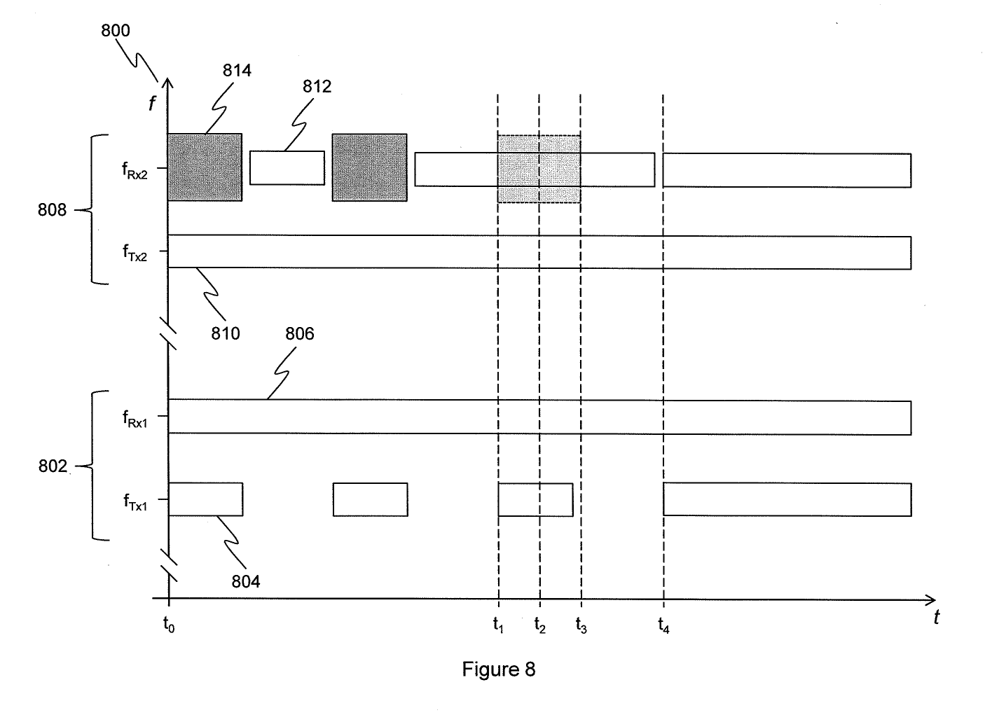

As an alternative, the inclusion of a test period may be achieved by scheduling the remote party to continue transmission of one of the afflicted received signals during a period in which both transmitted signals are scheduled to be transmitted, as will now be described with reference to FIG. 8.

As for the previous examples, a pair of signals allocated in frequency region 802, comprising transmitted signal 804 and received signal 806 modulated at frequencies f_{T×1} and f_{R×1} respectively, and a pair of signals allocated in frequency region 808, comprising transmitted signal 810 and received signal 812 modulated at frequencies f_{R×2} and f_{R×2} respectively are being transmitted and received. However, and as for the previous examples, the combination of transmitted signal 804 and transmitted signal 810 results in the generation of distortion component 814 near reception frequency f_{R×2}, overlapping received signal 812. Again, as a result the transceiver is desensitised to signals received at reception frequency f_{R×2}, and hence at time t₀ the transceiver is configured to operate in the partial time division duplex, frequency division duplex mode with respect to received signal 812 and transmitted signal 804.

In order to determine the extent of a subsequent desensitisation using a signal quality measurement process, a test period of full duplex, frequency division duplex operation is inserted between t₁ and t₃, whilst the transceiver is operating in the partial time division duplex, frequency division duplex mode. This is achieved by scheduling the remote party to continue transmission of received signal 812 throughout a period in which transmitted signal 804 is scheduled to be transmitted. The result is the reception of received signal 804 from time t₁ to time t₃, during which time distortion component 814 is also generated.

At time t₂, during the test period of full duplex, frequency division duplex operation, the transceiver performs a signal quality measurement process in order to measure a subsequent signal quality of signal 812. In this example, on the basis of the measured signal quality, the transceiver detects that it is no longer under a level of desensitisation to signals received at reception frequency f_{R×2}, that would result in unreliable reception of received signal 812, and therefore configures the transceiver to operate in a full duplex, frequency division duplex mode from time iₛ onwards.

In the example of FIG. 8, the subsequent signal quality of received signal 812 during the test period of full duplex, frequency division duplex operation was sufficient to allow for reliable reception. However, had the signal quality not been sufficient, any information carried by received signal 812 during the test period of full duplex, frequency division duplex operation may not have been successfully received by the transceiver. To prevent the need for a retransmission of such information, the remote party can be configured to transmit no meaningful data during the test period. In this case, there is no loss of bandwidth associated with the signal quality measurement process, as the information received during the test period is additional to the data transmitted during normal operation of the time division duplex, frequency division duplex mode.

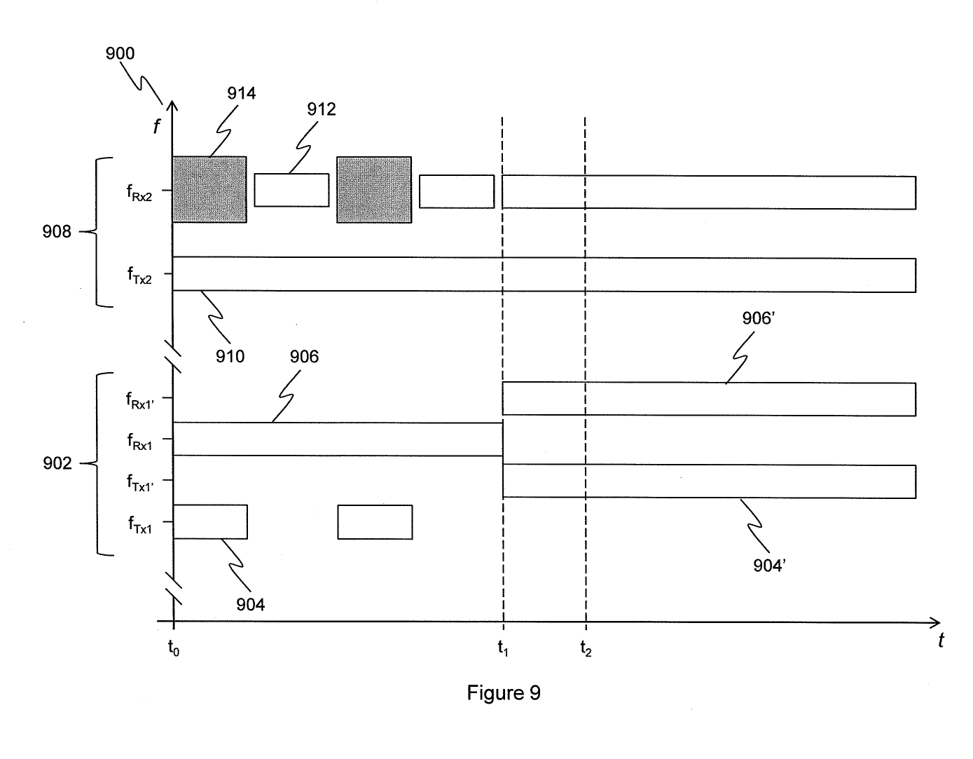

An alternative condition that can trigger the transceiver to be configured into the full duplex frequency division duplex mode is a change in carrier frequency of either a transmitted signal that is a contributor to the desensitisation, or of the afflicted received signal, as will be described with reference to FIG. 9.

At time t₁, a scheduled change in carrier frequency of the pair of signals in frequency region 902 occurs. This results in transmitted signal 904 being transmitted at frequency f_{T×1′}from time t₁ onwards (thereafter labelled 904′), and received signal 906 being transmitted at frequency f_{R×1′}from time t₁ onwards (thereafter labelled signal 906′). As a result, any distortion components generated by transmitted signal 904′, or the combination of transmitted signal 904′ and transmitted signal 910 will be generated at different frequencies after time t₁. Therefore, an assumption can be made that the transceiver is no longer affected by desensitisation at received frequency f_{R×2}, and the transceiver is configured into full duplex, frequency division duplex mode from time t₁ onwards. This assumption can be confirmed by a subsequent signal quality measurement process performed at time t₂.

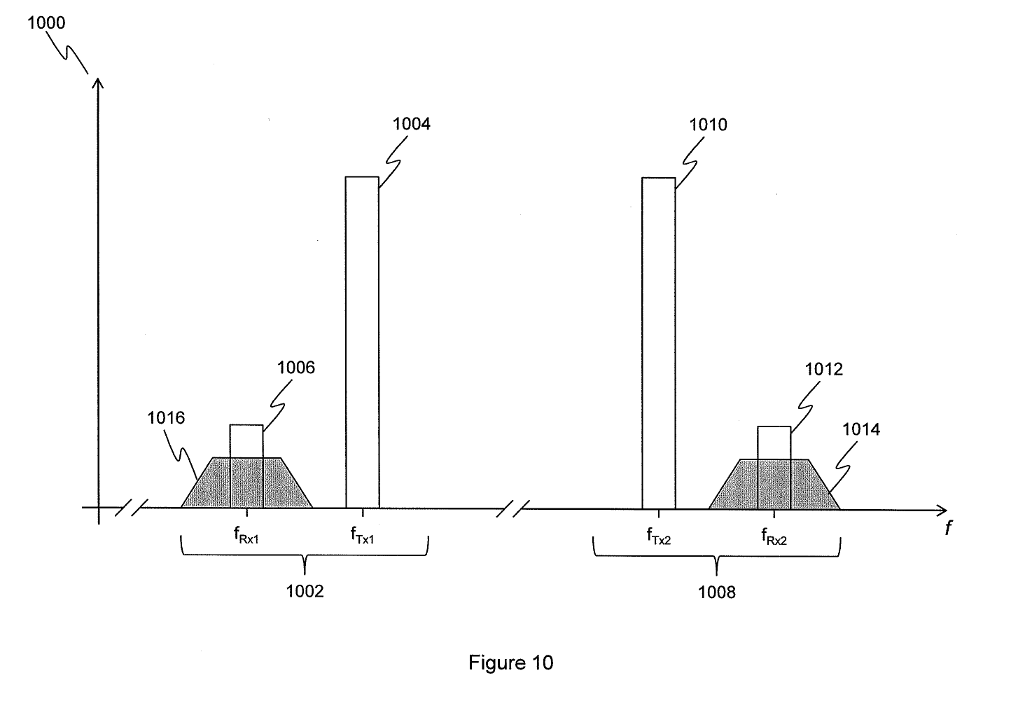

Under some combinations of carrier frequencies the transmitted signals may generate distortion components at more than one of the reception frequencies, as will now be explained with reference to FIG. 10. A first frequency region 1002 comprises transmitted signal 1004 and received signal 1006. Transmitted signal 1004 is modulated at transmission frequency f_{T×1}, and is used to transmit data from the transceiver to a remote party. Received signal 1006 is modulated at reception frequency f_{R×1}, and is used to transmit data from the remote party to the transceiver. Similarly, a second frequency region 1008 comprises transmitted signal 1010 and received signal 1012. Transmitted signal 1010 is modulated at transmission frequency f_{T×2}, and is used to transmit data from the transceiver to a remote party. Received signal 1012 is modulated at reception frequency f_{R×2}, and is used to transmit data from the remote party to the transceiver.

As can be seen, as a result of the specific frequency channels that have been allocated for communication, a distortion component 1014 has been generated close to the reception frequency f_{R×2}, i.e. overlapping received signal 1002. As explained above, distortion component 1014 could be an intermodulation component generated by the combination of transmitted signals 1004 and 1010, or it could be a harmonic component of transmitted signal 1004. Similarly, distortion component 1016 has been generated close to the reception frequency f_{R×1}, i.e. overlapping received signal 1006.

In this case, distortion component 1016 is an intermodulation component generated by the combination of transmitted signals 1004 and 1010. The effect of distortion components 1014 and 1016 being generated over received signals 1012 and 1006 is to desensitise the receiver to the reception of those signals. If the magnitudes of the generated distortion components are sufficiently large, the transceiver will be unable to reliably receive signals received at either reception frequency, thereby significantly impeding the operation of the transceiver.

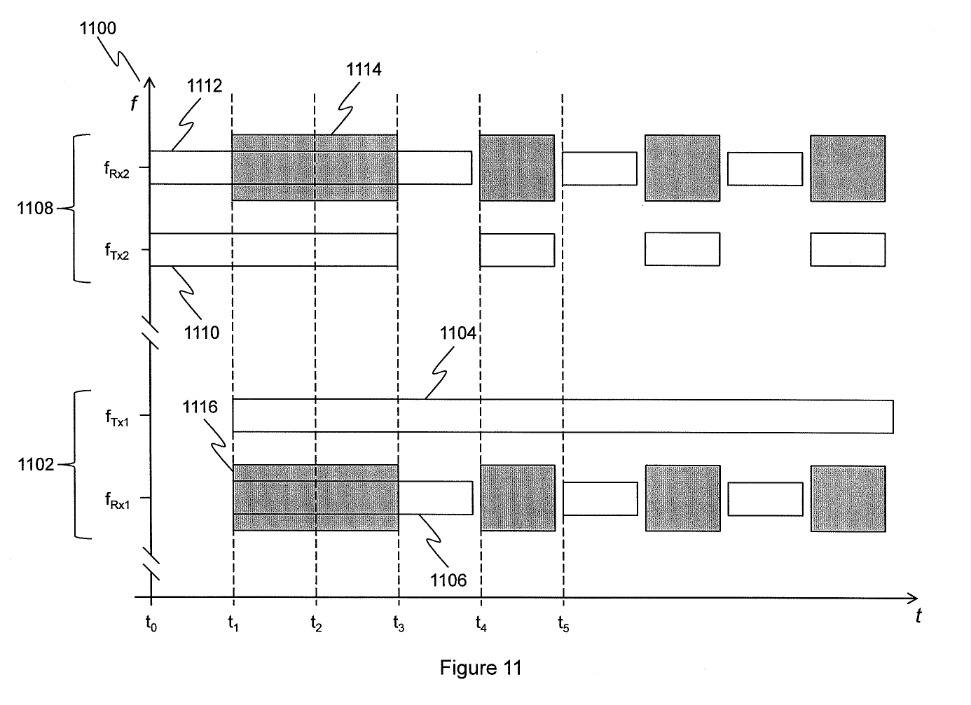

This problem is addressed by a yet further embodiment that will be described with reference to FIG. 11. At time t₁, a pair of signals allocated in frequency region 1102 (transmitted signal 1104 and received signal 1106 modulated at frequencies f_{T×1} and f_{R×1} respectively) also begin to be transmitted and received. The addition of transmitted signal 1104 causes distortion component 1114 to be generated near reception frequency f_{R×2}, overlapping received signal 1112, and distortion component 1116 to be generated near reception frequency f_{R×1}, overlapping received signal 1106. In this example, distortion components 1114 and 1116 are intermodulation components arising from the combination of transmitted signals 1104 and 1110. The result is desensitisation of the transceiver to signals received at reception frequency f_{R×1} and reception frequency f_{R×2} beginning at time t₁. At time t₂, the transceiver detects the desensitisation to signals received at reception frequencies f_{R×1} and f_{R×2}, and configures the transceiver so that one of the transmitted signals 1104 and 1110 is transceived in a partial time division duplex, frequency division duplex mode with respect to both received signal 1112 and received signal 1106, from time t₃ onwards. As both distortion components result from the intermodulation of transmitted signals 1104 and 1110, either of the transmitted signals can be selected for transmission in the partial time division duplex, frequency division duplex mode. In this example, transmitted signal 1110 is selected.

Thus between time t₃ and time t₄, the transceiver suspends transmission of transmitted signal 1110 whilst received signals 1106 and 1112 are being received. As transmitted signal 1110 is not being transmitted during the period between time t₃ and time t₄, distortion components 1114 and 1116 are not generated, thereby allowing received signals 1106 and 1112 to be reliably received.

Between time t₄ and time t₅, the transceiver resumes transmission of transmitted signal 1110 whilst received signals 1106 and 1112 are not being received. As transmitted signal 1104 and transmitted signal 1110 are now being transmitted again, distortion components 1114 and 1116 are also generated, resulting in desensitisation of the transceiver to signals received at reception frequencies f_{R×1} and f_{R×2}, during the period between time t₄ and time t₅. However, as received signals 1106 and 1112 are not being received during this period, this does not affect the reliable operation of the transceiver. This operation continues from time t₅ onwards, thereby allowing reliable communication to continue despite the generation of distortion components 1114 and 1116.

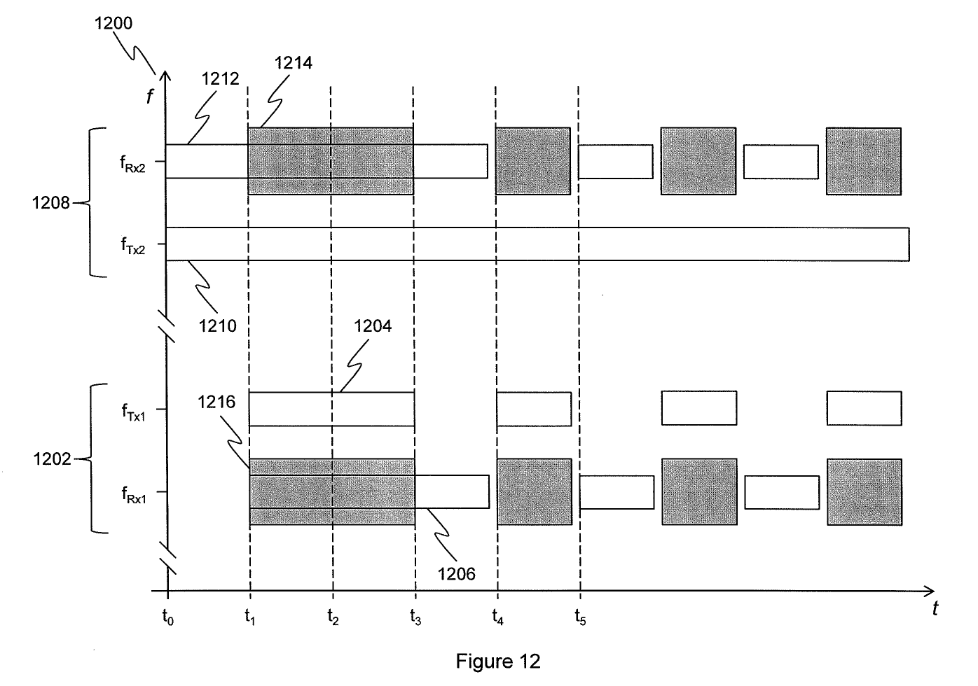

FIG. 12 is similarly concerned with the problem introduced above with reference to FIG. 10. At time t₀ a pair of signals allocated in frequency region 1208 (transmitted signal 1210 and received signal 1212 modulated at frequencies f_{T×2} and f_{R×2} respectively) are being transmitted and received. At time t₁, a pair of signals allocated in frequency region 1202 (transmitted signal 1204 and received signal 1206 modulated at frequencies f_{T×1} and f_{R×1} respectively) also begin to be transmitted and received. The addition of transmitted signal 1204 causes distortion component 1214 to be generated near reception frequency f_{R×2}, overlapping received signal 1212, and distortion component 1216 to be generated near reception frequency f_{R×1}, overlapping received signal 1206. In this example, distortion component 1214 is a harmonic component of transmitted signal 1204, and distortion component 1216 is an intermodulation component arising from the combination of transmitted signals 1204 and 1210. The result is desensitisation of the transceiver to signals received at reception frequency f_{R×1} and reception frequency f_{R×2} beginning at time t₁.

At time t₂, the transceiver detects the desensitisation to signals received at reception frequencies f_{R×1} and f_{R×2}, and configures the transceiver so that one of the transmitted signals 1204 and 1210 are transceived in a partial time division duplex, frequency division duplex mode with respect to both received signal 1212 and received signal 1206, from time t₃ onwards. As distortion component 1214 is a harmonic of transmitted signal 1204, transmitted signal 1204 is selected for transmission in the partial time division duplex, frequency division duplex mode.

Between time t₃ and time t₄, the transceiver suspends transmission of transmitted signal 1204 whilst received signals 1206 and 1212 are being received. As transmitted signal 1204 is not being transmitted during the period between time t₃ and time t₄, distortion components 1214 and 1216 are not generated, thereby allowing received signals 1206 and 1212 to be reliably received.

Between time t₄ and time t₅, the transceiver resumes transmission of transmitted signal 1204 whilst received signals 1206 and 1212 are not being received. As transmitted signal 1204 and transmitted signal 1210 are now being transmitted again, distortion components 1214 and 1216 are also generated, resulting in desensitisation of the transceiver to signals received at reception frequencies f_{R×1} and f_{R×2}, during the period between time t₄ and time t₅. However, as received signals 1206 and 1212 are not being received during this period, this does not affect the reliable operation of the transceiver. This operation continues from time t₅ onwards, thereby allowing reliable communication to continue despite the generation of distortion components 1214 and 1216.

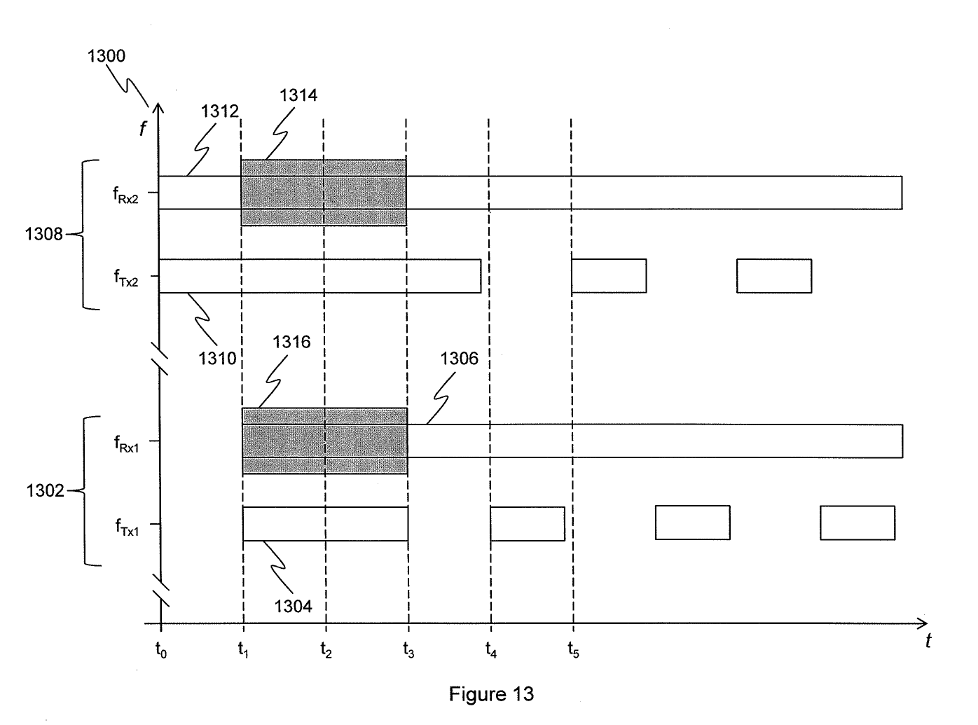

As discussed previously, in many usage scenarios, it is desirable to maintain the maximum aggregate bandwidth of the received signals whilst suffering desensitisation at a reception frequency. The techniques discussed previously are equally applicable when intermodulation distortion causes desensitisation at both reception frequencies, as will now be described in relation to FIG. 13.

At time t₀ a pair of signals allocated in frequency region 1308 (transmitted signal 1310 and received signal 1312 modulated at frequencies f_{T×2} and f_{R×2} respectively) are being transmitted and received. At time t₁, a pair of signals allocated in frequency region 1302 (transmitted signal 1304 and received signal 1306 modulated at frequencies f_{T×1} and f_{R×1} respectively) also begin to be transmitted and received. The addition of transmitted signal 1304 causes distortion component 1314 to be generated near reception frequency f_{R×2}, overlapping received signal 1312, and distortion component 1316 to be generated near reception frequency f_{R×2}, overlapping received signal 1306. In this example, distortion components 1314 and 1316 are intermodulation components arising from the presence of transmitted signal 1304 and transmitted signal 1310. The result is desensitisation of the transceiver to signals received at reception frequency f_{R×1} and reception frequency f_{R×2}, beginning at time t₁.

At time t₂, the transceiver detects the desensitisation to signals received at reception frequencies f_{R×1} and f_{R×2}, and configures the transceiver so that transmitted signal 1304 and transmitted signal 1310 are transmitted in a partial time division duplex, frequency division duplex mode from time t₃ onwards.

Between time t₃ and time t₄, the transceiver suspends transmission of transmitted signal 1304 whilst signal 1310 is being transmitted. As transmitted signal 1304 is not being transmitted during the period between time t₃ and time t₄, distortion components 1314 and 1316 are not generated, thereby allowing received signals 1304 and 1312 to be reliably received.

As can be seen, between time t₄ and time t₅, the transceiver suspends transmission of transmitted signal 1310 whilst signal 1304 is being transmitted. As transmitted signal 1310 is not being transmitted during the period between time t₃ and time t₄, distortion components 1314 and 1316 are still not generated, thereby allowing received signals 1304 and 1312 to continue being reliably received. Thus, while it is the case that transmitted signal 1304 and transmitted signal 1310 are both being transmitted, this no longer happens simultaneously, meaning that distortion components 1314 and 1316 are no longer generated. This operation continues from time t₅ onwards, thereby allowing reliable communication to continue despite the initial generation of distortion components 1314 and 1316.

In various embodiments an apparatus is provided comprising the aforementioned transceiver hardware, such as a user terminal, or one or more components thereof such as for example a wireless modem configured for use in a user terminal.

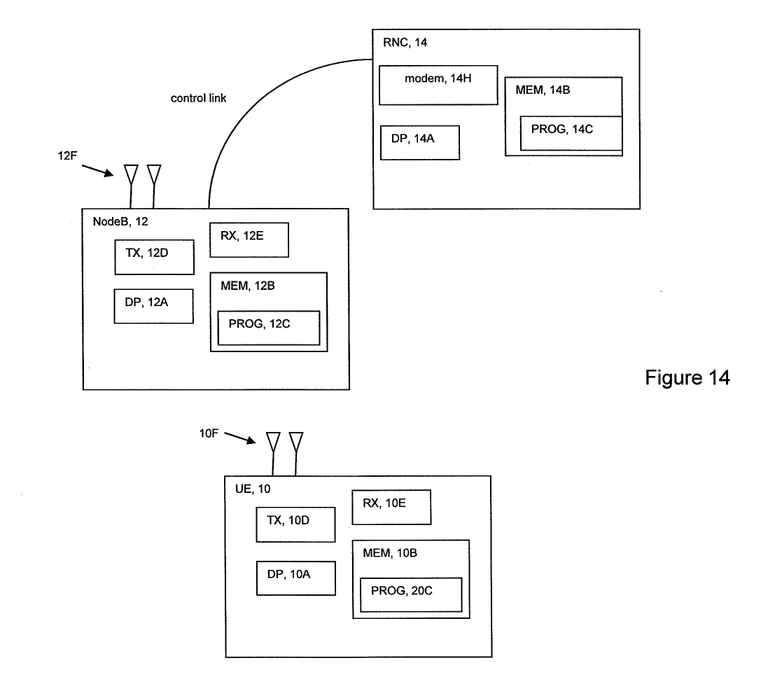

Reference is now made to FIG. 14 for illustrating a simplified block diagram of various electronic devices and apparatus that are suitable for use in practicing the exemplary embodiments. In FIG. 14 a serving cell/network access node 12 is adapted for communication over a wireless link with a mobile apparatus, such as a mobile terminal or UE 10. The network access node 12 may be a NodeB as identified at FIG. 14, an eNodeB (of an E-UTRAN system), an access point AP, a remote radio head or relay station, or other type of base station/cellular access node.

The UE 10 includes processing means such as at least one data processor (DP) 10A, storing means such as at least one computer-readable memory (MEM) 10B storing at least one computer program (PROG) 10C, and also communicating means such as a receiver RX 10E and a transmitter TX 10D configured according to embodiments for bidirectional wireless communications with the network access node 12 via one or more antennas 10F.

The network access node 12 similarly includes processing means such as at least one data processor (DP) 12A, storing means such as at least one computer-readable memory (MEM) 12B storing at least one computer program (PROG) 12C, and communicating means such as a transmitter TX 12D and a receiver RX 12E for bidirectional wireless communications with the UE 10 via one or more antennas 12F. The RNC 14 represents any other higher network node or serving gateway providing connectivity to a broader network (a publicly switched telephone network or the Internet for example), and some systems may not have such a higher network node between the access node 12 and the Internet.

Similarly, the RNC 14 includes processing means such as at least one data processor (DP) 14A, storing means such as at least one computer-readable memory (MEM) 14B storing at least one computer program (PROG) 14C, and communicating means such as a modem 14H for bidirectional communication with the network access node 12 via the control link.

It will be understood that the various embodiments of the transmitter 10E described herein comprise circuitry that may be provided by a single chip or integrated circuit or plural chips or integrated circuits, optionally provided as a chipset, an application-specific integrated circuit (ASIC), field-programmable gate array (FPGA), etc. The chip or chips may comprise circuitry (as well as possibly firmware) for embodying at least one or more of the aforementioned components, including control circuitry, digital signal processor or processors, baseband circuitry and radio frequency circuitry, which are configurable so as to operate in accordance with the exemplary embodiments. In this regard, the exemplary embodiments may be implemented at least in part by computer software stored in memory and executable by a processor, or by hardware, or by a combination of tangibly stored software and hardware (and tangibly stored firmware).

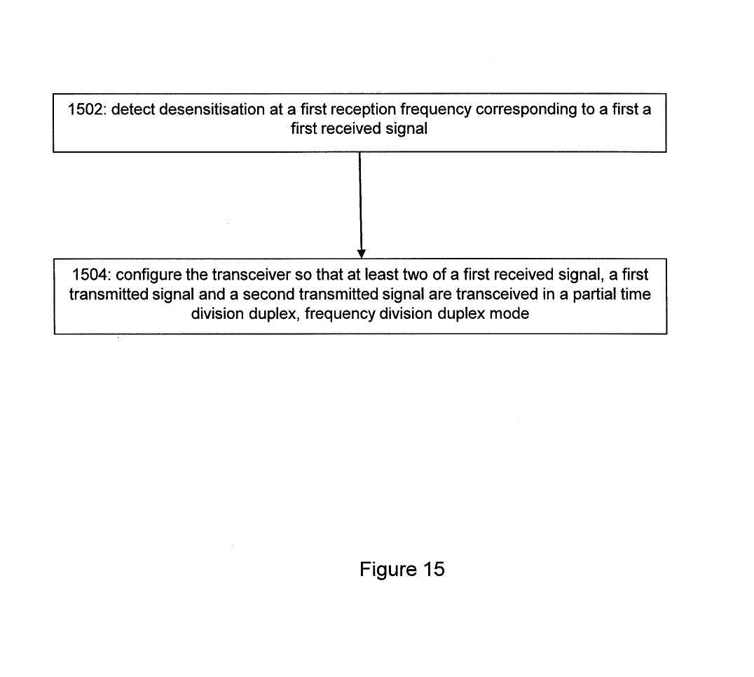

FIG. 15 is a logic flow diagram that describes an exemplary embodiment from the perspective of the UE 10, and in this regard, the Figure represents steps performed by one or a combination of the aforementioned control circuitry, digital signal processor or processors, baseband circuitry and radio frequency circuitry

At step 1502, the transceiver apparatus detects desensitisation at a first reception frequency corresponding to a first a first received signal received from access point 12. Then, at step 1504, the transceiver apparatus configures the transceiver so that at least two of the first received signal, a first transmitted signal and a second transmitted signal are transceived in a partial time division duplex, frequency division duplex mode.

The above embodiments are to be understood as illustrative examples. Further embodiments are envisaged. For example, embodiments are equally applicable in circumstances using greater or fewer numbers of transceived signals. A single transmitted signal could generate a harmonic distortion component over a single received signal if the transmission and reception frequencies are allocated sufficiently far apart. Equally, transmitting more than two transmitted signals creates a larger number of intermodulation and harmonic components. Generally speaking, as the number of transceived signals increases, so does the likeliness of desensitisation at a reception frequency. Furthermore, the various signals need not be part of the same radio communication scheme. For example, transmitted signals using one radio communication scheme may create distortion components that desensitise the receiver to receiving other radio access technologies, such as GPS, WiFi etc. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An apparatus comprising:
a transceiver capable of transceiving at least a first received signal modulated at a first reception frequency, a first transmitted signal modulated at a first transmission frequency and a second transmitted signal modulated at a second transmission frequency, wherein, responsive to detecting desensitisation at the first reception frequency, the apparatus is configured to cause the transceiver to transceive at least two of the first received signal, the first transmitted signal and the second transmitted signal in a partial time division duplex, frequency division duplex mode.

2. An apparatus according to claim 1, wherein the apparatus is further configured to perform a signal quality measurement process, the signal quality measurement process comprising measuring a signal quality associated with the first received signal, whereby to detect said desensitisation at the first reception frequency.

3. An apparatus according to claim 2, wherein the apparatus is configured to compare said measured signal quality associated the first received signal with a first predetermined threshold level, whereby to detect said desensitisation at the first reception frequency.

4. An apparatus according to claim 1, wherein the apparatus is further configured to cause data to be transmitted to the source of said first received signal, in order to schedule communication in said partial time division duplex, frequency division duplex mode, said transmitted data comprising data indicative of said detected desensitisation at the first received frequency.

5. An apparatus according to claim 1, wherein the apparatus is configured to cause the transceiver to transceive the first received signal and at least one of the first transmitted signal and the second transmitted signal in the partial time division duplex, frequency division duplex mode.

6. An apparatus according to claim 5, wherein the apparatus is configured to select between the first transmitted signal and the second transmitted signal for transmission in the partial time division duplex, frequency division duplex mode in dependence on a bandwidth associated with said first transmitted signal and a bandwidth associated with said second transmitted signal.

7. An apparatus according to claim 5, wherein, responsive to detecting that said desensitisation at the first reception frequency is due to a harmonic associated with one of the first transmitted signal and the second transmitted signal, the apparatus is configured to select between the first transmitted signal and the second transmitted signal for use in the partial time division duplex, frequency division duplex mode in dependence on an association with said harmonic.

8. An apparatus according to claim 1, wherein the apparatus is configured to cause the transceiver to transceive the first transmitted signal and the second transmitted signal in the partial time division duplex, frequency division duplex mode.

9. An apparatus according to claim 1, wherein the apparatus is configured to schedule a period of full duplex, frequency division duplex operation whilst configured in said partial time division duplex, frequency division duplex mode, whereby to enable detection of subsequent desensitisation at the first reception frequency.

10. An apparatus according to claim 9, wherein the apparatus is configured to perform a signal quality measurement process during said period of full duplex, frequency division duplex operation, whereby to measure a subsequent signal quality associated with the first received signal.

11. An apparatus according to claim 9, wherein the apparatus is further configured to compare said subsequent signal quality associated the first received signal with a second predetermined threshold level.

12. An apparatus according to claim 11, wherein, responsive to said subsequent signal quality associated the first received signal exceeding the second predetermined threshold level, the apparatus is configured to cause the transceiver to transceive the first received signal, the first transmitted signal and the second transmitted signal in a full duplex, frequency division duplex mode.

13. An apparatus according to claim 1, wherein, responsive to a change in frequency of one or more of the first transmission frequency, the first reception frequency or the second transmission frequency, the apparatus is further configured to cause the transceiver to transceive the first received signal, the first transmitted signal and the second transmitted signal in a full duplex, frequency division duplex mode.

14. An apparatus according to claim 1, wherein the apparatus is configured to cause the transceiver to receive a second received signal modulated at a second reception frequency.

15. An apparatus according to claim 14, wherein, responsive to detecting desensitisation at the second reception frequency, the apparatus is further configured to:
determine that said desensitisation at the second reception frequency is due to an intermodulation component associated with the first transmitted signal and the second transmitted signal; and
cause the transceiver to transceive the second received signal in the same time division duplex mode as said first transmitted signal.

16. An apparatus according to claim 1, wherein the partial time division duplex, frequency division duplex mode is a half-duplex scheme.

17. An apparatus according to claim 1, wherein the partial time division duplex, frequency division duplex mode is an asynchronous time division duplex scheme.

18. An apparatus according to claim 1, wherein the first transmission frequency and the second transmission frequency are associated with different frequency bands in a communication scheme associated with one or more of said first transmitted signal and said second transmitted signal.

19. A method of configuring a transceiver to transmit and receive signals at a plurality of frequencies including at least a first transmitted signal modulated at a first transmission frequency, a first received signal modulated at a first reception frequency, and a second transmitted signal modulated at a second transmission frequency, the method comprising:
responsive to detecting desensitisation at the first reception frequency, configuring the transceiver so that at least two of the first received signal, the first transmitted signal and the second transmitted signal are transceived in a partial time division duplex, frequency division duplex mode.

20. A non-transitory computer-readable storage medium comprising a set of computer-readable instructions stored thereon, which, when executed by a processing system, cause the processing system to carry out a method of configuring a transceiver to transmit and receive signals at a plurality of frequencies including at least a first transmitted signal modulated at a first transmission frequency, a first received signal modulated at a first reception frequency, and a second transmitted signal modulated at a second transmission frequency, the method comprising:
responsive to detecting desensitisation at the first reception frequency, configuring the transceiver so that at least two of the first received signal, the first transmitted signal and the second transmitted signal are transceived in a partial time division duplex, frequency division duplex mode.
